(19) United States
(12) Patent Application Publication
(10) Pub. No.: US 2012/0233155 A1
(43) Pub. Date: Sep. 13, 2012

(54) Method and System For Context Sensitive Content and Information in Unified Communication and Collaboration (UCC) Sessions

(75) Inventors: Jonathan Gallmeier, Austin, TX (US); Krishna Sai, Austin, TX (US); Michael Tucker, Austin, TX (US); Ed Brakus, San Francisco, CA (US)

(73) Assignee: POLYCOM, INC., Pleasanton, CA (US)

(21) Appl. No.: 13/417,561

(22) Filed: Mar. 12, 2012

Related U.S. Application Data
(60) Provisional application No. 61/451,195, filed on Mar. 10, 2011.

(51) Int. Cl. G06F 17/30

(52) U.S. Cl. 707/722; 707/E17.014

(57) ABSTRACT

Systems and methods are disclosed to identify and generate keyword searches in real-time or near real-time for active participants in an on-going Audio, Video and Data Collaboration meeting (also referred to as “Unified Communications and Collaboration” or UCC). In one embodiment, multiple input sources are screened to detect text data and generate search strings from the deciphered keywords. Keywords are deciphered from presentation materials and other forms of data input to a UCC (e.g., documents, video, and audio). Keywords and generated search strings can then be presented to one or more participants for selection (e.g., hyperlink) to retrieve and present supporting material relative to a topic of discussion or point of interest in the UCC. Alternatively, recorded content can be search during or prior to playback to allow incorporation of disclosed embodiments and concepts.

### CROSS REFERENCE TO RELATED APPLICATIONS

This application is a non-provisional application based on and claiming priority to Provisional U.S. Patent Application Ser. No. 61/451,195, filed 10 Mar. 2011, (having the same title and inventors as this application) which is hereby incorporated by reference in its entirety.

### FIELD OF THE DISCLOSURE

This disclosure relates generally to the field of video conferencing. More particularly, but not by way of limitation, this disclosure relates to a method of providing an interface to participants of conference meetings to allow the participants to initiate a search for supporting information in real-time or near real-time. Conference participants could be presented with search options to find supporting material relative to what conference participants are discussing or to search based on keywords derived from conference presentation materials.

### BACKGROUND

In today's corporate environment, it is typical to schedule meetings and to conduct those meetings via meeting control devices including video conferencing devices. A participant in an Audio, Video and Data Collaboration meetings (referred to henceforth as “Unified Communications and Collaboration” or UCC) will often require supporting information to understand topics of a meeting. Currently, a participant will typically keep notes and later perform a manual search to gather background information about a topic that has already been discussed. It is not uncommon for a participant to see information provided by subject matter experts in the context of a meeting that the participant does not fully understand. The information provided in a UCC is typically presented in the form of power point presentations, audio/video files, documents, or other content shared with the assistance of conference control devices.

To overcome the problems associated with a time delay in finding supporting information and other problems, it would be desirable to create a system and method to allow conference participants to select automatically generated selection links (e.g., hyperlinks) during the UCC session so that they might better understand topics of an ongoing conversation (or presentation) as needed. Additionally, sometimes and most routinely, these meetings are conducted with participants in multiple locations. However, the concepts disclosed herein are not limited to multi-location meetings a meeting in a single conference room configured with a device according to the disclosed embodiments could also benefit from concepts of this disclosure.

### BRIEF DESCRIPTION OF THE DRAWINGS

FIG. 1 illustrates, in block diagram form, example equipment available to support a UCC session.

FIG. 2 illustrates, in block diagram form, an outline of one possible pipe line for gathering context sensitive content and information in a UCC according to at least one embodiment of this disclosure.

FIG. 3 illustrates, in block diagram form, additional modules which could be added to the capabilities shown in FIG. 2 to allow one or more user to tune functionality according to one disclosed embodiment.

FIG. 4 shows, in block diagram form, a processing device which could be one or more programming devices communicatively coupled to each other to perform some or all of the methods and embodiments disclosed herein.

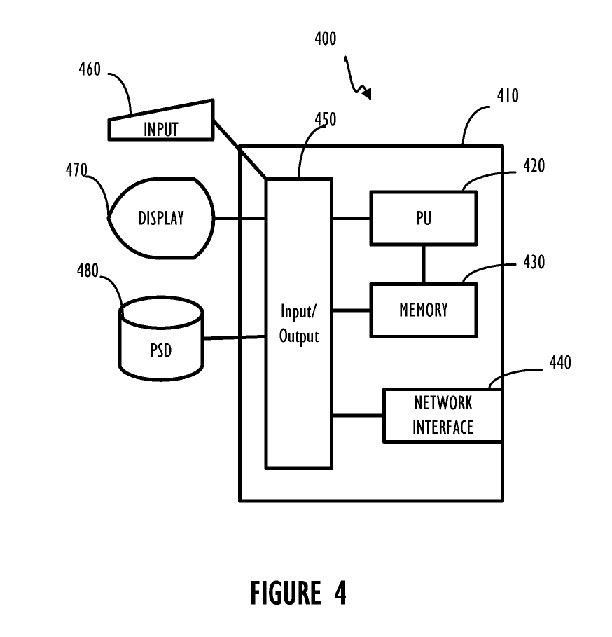

### DETAILED DESCRIPTION

Systems and methods to decipher information from meeting content, perform text extraction from presented materials (including audio and video), and to automatically generate relevant information searches from the deciphered information are disclosed. As stated above, it would be desirable to provide a participant in an Audio, Video and Data Collaboration meetings (referred to henceforth as “Unified Communications and Collaboration” or UCC) with supporting information to understand topics of a meeting. The supporting information could be provided at or near a point in time when a topic is being discussed/presented at the meeting. For example, if a meeting presenter is explaining a holding of a court, a selection link (e.g., hyperlink based on an Internet URL) to the actual court decision could be generated and placed on a screen available to one or more participants. Then, by using the automatically generated link, a participant who wants to open and scan the court holding, while the meeting presenter is discussing the case (or shortly thereafter), can easily do so. As explained further below, links can be automatically generated by performing text extraction from a plurality of sources of information in a multi-media meeting and performing search keyword mining on the extracted text. In an audio only conference, speech to text translation software could be used as a step in finding keywords. Also, generated links may be selected during the UCC or can be stored for later access as a sort of “references” list for people interested in the topics of the UCC.

In addition to any “planned” content that may be shared before a meeting, many types of materials can be shared for the first time during a UCC session; these materials include presentations, lectures, and other meeting materials. Presentation materials often contain keywords, technical terms, and vocabulary that may be unfamiliar to an individual participant. In the past, a participant would likely have to perform a manual and separate search either while the meeting is in progress or after the meeting has concluded. When an individual participant is presented an unfamiliar term, a participant could be forced to write down the perceptible keywords and perform a search, often on the Internet, at some later time to determine the meaning of the keyword and gather additional information about the topic of interest. This disclosure is directed to automating the process of locating context specific content and information while the UCC session is still active. Additionally, UCC sessions are often recorded for subsequent play back to actual participants or for participants unable to attend the actual meeting. According to one embodiment, a keyword search could produce selection links imbedded into the recording of the meeting content to allow a subsequent reviewer to easily access additional supporting content. Alternatively, at the time of meeting playback (or simply at a time after recording), the recorded information could be scanned and processed according to the disclosed embodiments to allow participants watching the recorded meeting to benefit from the concepts of this disclosure.

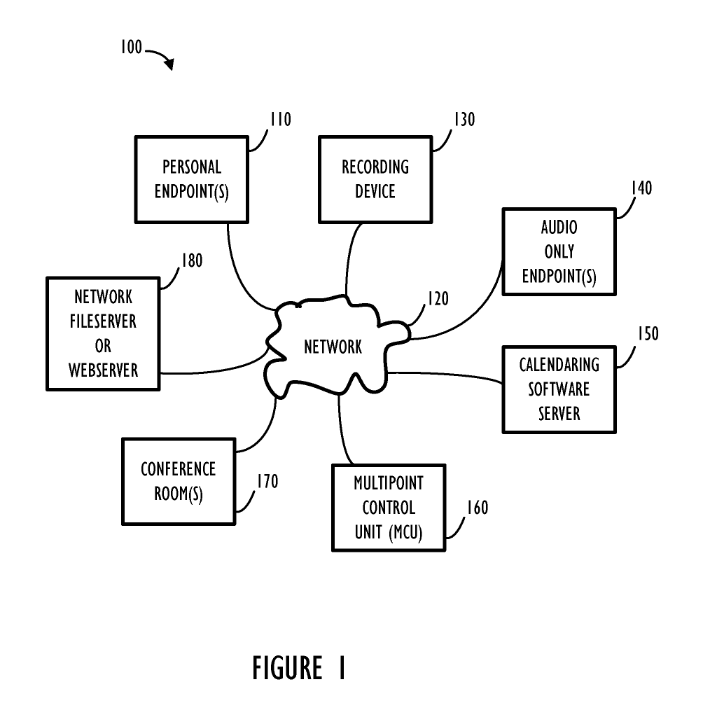

FIG. 1 shows, in block diagram form, example equipment 100 available to a corporation for facilitating a meeting. The meeting may take place at a single location or between multiple locations with potentially differing numbers of participants at the different locations. When participants of a meeting are not all at one location, a conference can be initiated to connect the multiple locations. A conference may be an audio only conference, a video conference, a data conference or a combination thereof. In one type of hybrid conference some locations can have full audio and video while other locations may be limited to audio only or be able to receive video and only supply audio (e.g., video from a computer over a network and audio via a telephone).

As shown in FIG. 1, each of the different types of equipment available to support a meeting can be communicatively coupled via network 120. Network 120 represents multiple network types and network technologies known to those of skill in the art (e.g., POTS, Ethernet, TCP/IP, packet switched, circuit switched, cellular, LAN and WAN). Each of the different types of equipment shown in FIG. 1 represents a logical capability and each of these logical capabilities may be combined and provided by a single physical device. Also, each of the different types of equipment may or may not include a programmable control device capable of being programmed to provide extended capabilities to the equipment via software, middleware or firmware, etc. Additionally, each type of equipment may be enabled to interface with the calendaring server 150 via a client application executing on the device or otherwise.

FIG. 1 shows a personal endpoint 110. Each of a potential plurality of personal endpoints 110 may include a personal conferencing system or optionally a camera input device connected to a personal computer. A single personal endpoint 110 may be used by a single participant of a conference or in some cases may support a small number of people. A personal computer acting as a personal endpoint 110 can include a processor that has been specifically programmed with software allowing it to connect to and participate in a conference. One example of such software is the CMA Desktop Video Soft Client available from Polycom Inc., Pleasanton, Calif.

FIG. 1 also shows a recording device 130 communicatively coupled to network 120. Recording device 130 can allow for recording the audio portion of the conference or the audio and video portion of the conference. Recording device 130 can be configured to record the data from selected video capture devices (e.g., camera) or all video capture devices supporting a conference. Recording device 130 may further contain a programmable control device programmed to interface recording device 130 with other devices connected to network 120. In particular, recording device 130 may be programmed to provide information and recorded content to network fileserver or webserver 180 and/or calendaring software server 150. Furthermore, recording device 130 may be integrated into the same physical device providing other logical capabilities shown in FIG. 1. Examples of recording device 130 include the recording and streaming server RSS™ 2000 and the Polycom Video Media Center (VMC) 1000 each available from Polycom, Inc., Pleasanton, Calif. (RSS is a registered trademark of Polycom, Inc.).

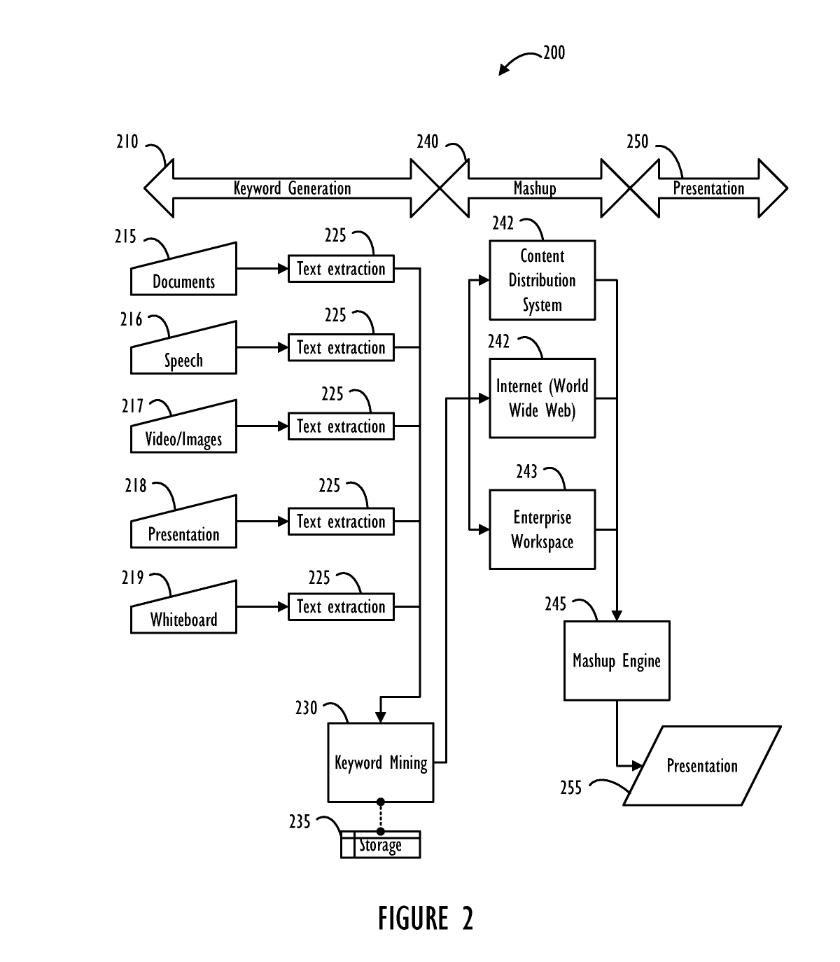

Referring now to FIG. 2, block diagram 200, illustrates three main phases of automatically generating and presenting search information results to a participant of a UCC session. The three main phases consist of Keyword Generation 210, Mashup 240 and Presentation 250. In Keyword Generation 210, input can be received from a variety of sources, including but not limited to: documents 215, speech 215, video or photos 217, presentations 218, and whiteboard 219 content. Each of these sources can be processed using a multitude of processing techniques to determine content of provided material (e.g., text extraction module 225, object recognition software, speech recognition capabilities, etc.) and then derived keywords can be generated from the information using a keyword text extractor 225 or mining engine 230. Documents 215 (e.g., a Microsoft word document or a pdf document) can be processed to produce a plain text file equivalent of the original information and used to produce selection links referencing additional support information related to the provided topical information.

Computer presentation 218 content (like Microsoft PowerPoint) and text-based documents 215 often will have existing plain text file conversion software that can perform the conversion. Speech 216 to text software can be used to perform a speech to text conversion in near real-time. Whiteboard 219 data can be converted to image data via a camera or electronic whiteboard. Image data can then be processed by a handwriting recognition software module to produce a text file. Video and pictures 217 (photographs or hand-drawn pictures) can be mined for data using an object recognition software module to recognize common objects. In addition, metadata contained within photographs can be used to gather additional information. Videos associated with a video conference can be associated with meeting invites and associated text information.

After text has been extracted from the plurality of available data sources, the extracted text could be passed into a keyword extraction engine and mined for keywords by a keyword mining 230 engine (optionally connected to storage repository 235 to assist data mining). Several different keyword extraction engines are commercially available (e.g., www.opencalais.com, www.extractor.com). After Keyword Generation 210 phase has completed a Mashup 240 phase could begin.

A mashup is known in web development as a web page or application that uses and combines data, presentation or functionality from two or more sources to create new services. The main characteristics of a mashup, such as that performed by mashup engine 245 underlying mashup phase 240, are combination, visualization, and aggregation. A mashup can be used to make existing data more useful, such as, collecting extracted keywords and generating search strings to find data related to a UCC session as in certain disclosed embodiments.

Additionally, once the keywords are generated, they may be locally stored, and presented into a variety of search engines to generate content or information relevant to the UCC session. For example the list of keywords maybe input into an enterprise content distribution system 242 (like the VMC product from Polycom mentioned above), the World Wide Web on the Internet 242 (e.g., Google or Yahoo search engines), or Enterprise workspaces 243 like Microsoft SharePoint. The search results can then be passed through a Mashup engine 245 which could be used to collect all the results from the search engines and generate useful links or information (e.g., based on the no. of hits, type of content, lapsed time, etc).

Next, a Presentation 250 phase could begin. Once results are available, the results could be presented 255 to the UCC session participants in a variety of ways—for example, results could be displayed in a web browser on the PC or a laptop of a session participant, or on a display connected to a video conferencing appliance, or even a phone with a display. Once the information link(s) are displayed, participants could activate the link to retrieve supporting information and view its content, or share this further background with the rest of the UCC session participants.

To further enhance the concepts of automatic link generation, a user may create a user profile to explain a level of expertise on certain topics. For example, a user may set a profile to identify themselves as an expert in computer concepts and a novice in graphics processing. In such a case when that user attends a conference on computer graphics reference links can be generated for concepts pertaining to graphics and reference links can be suppressed for concepts generally related to computing. Thus the user profile may be used to automatically augment the concepts of filtering described above and provide for individualization of automatically generated reference links. Levels of expertise could be described, for example, on a scale of 1 to 10 with 10 being highly knowledgeable on the topic. In this example the profile might state Computing=10; Graphics Processing=4. A user profile could also have preferences to indicate if the user would like general definitional links to be presented. Alternatively to a user profile, a participant could define a “session” expertise level for a particular meeting topic (or for expected topic of meeting) so that general information could be obtained or only specific material would be maintained. For example, an expertise level of “Novice” would cause links to be generated for any acronyms mentioned in the meeting so the novice participant could quickly get a definition. In contrast, an expertise level of “Expert” would suppress acronym definitions because the expert can be expected to know the prevalent acronyms of a topic. As should be apparent many combinations and permutations of the above profile and session filters are possible.

A meeting participant could also have a user interface to the meeting with buttons to perform certain actions. For example, there could be a “definition” button. When the definition button is pressed the system could determine which words, phrases or acronyms were recently used (e.g., last minute or 30 seconds) and present selection links for definitions of the recently used terminology. Users could also have a “background” button that could search for background information pertaining to a topic under discussion or being presented at that time. In another example, a user could have a “translate” button. The translate button could be helpful for a bilingual person to receive assistance if they are listening in their non-native language and a word or phrase is used that they don't understand. Again, many different possible user interface buttons could be defined to cause an action based on an automatic determination of a topic under discussion or information being presented.

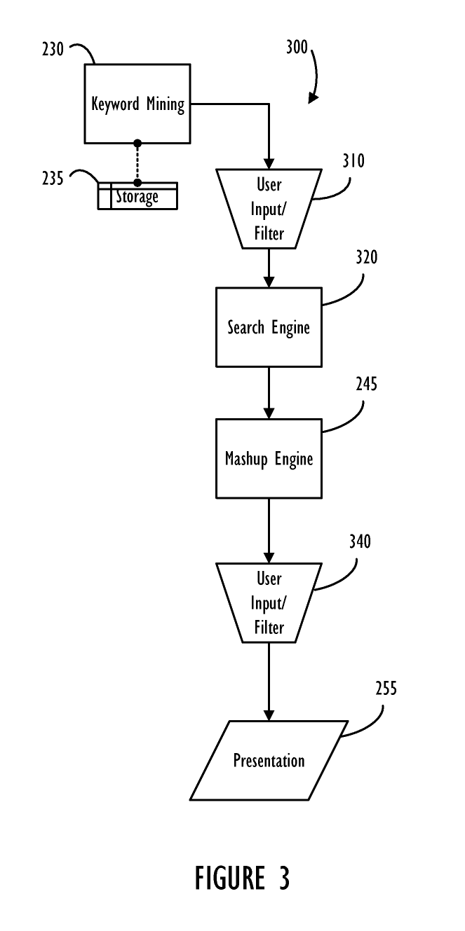

Referring now to FIG. 3, block diagram 300 illustrates additional modules which could be added to the capabilities shown in FIG. 2 to allow one or more users to tune functionality according to one disclosed embodiment. Optional modules could be added to the Keyword mining 130 engine and the Mashup Engine 245. The Optional modules could allow for user input filters 310 to be applied to the mined keywords prior to providing the keywords to a search engine 320. Additionally, user input filters 340 could be applied to the output of the search prior to presentation 255 of links. Application of filters at one or both of these points could let users tune the functionality, for example the users may decide to search based on specific keywords rather than all available keywords, or to focus on a specific search result or result type. For example, if the meeting topic is concerned with surgical techniques then the results could be filtered such that they are within the context of medical information.

Referring now to FIG. 3, an example conferencing device 300 is shown. Example conferencing device 300 comprises a programmable control device 310 which may be optionally connected to input 360 (e.g., keyboard, mouse, touch screen, etc.), display 370 or program storage device (PSD) 380. Also, included with program device 310 is a network interface 340 for communication via a network with other conferencing and corporate infrastructure devices (not shown). Note network interface 340 may be included within programmable control device 310 or be external to programmable control device 310. In either case, programmable control device 310 will be communicatively coupled to network interface 340. Also note program storage unit 380 represents any form of non-volatile storage including, but not limited to, all forms of optical and magnetic storage elements including solid-state storage. Examples of conferencing device 300 include but are not limited to, personal computers, video conferencing endpoints, video conferencing data recorders, and multipoint control units (MCUs).

Program control device 310 may be included in a conferencing device and be programmed to perform methods in accordance with this disclosure (e.g., those illustrated in FIG. 2). Program control device 310 comprises a processor unit (PU) 320, input-output (I/O) interface 350 and memory 330. Processing unit 320 may include any programmable controller device including, for example, the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 330 may include one or more memory modules and comprise random access memory (RAM), read only memory (ROM), programmable read only memory (PROM), programmable read-write memory, and solid state memory. One of ordinary skill in the art will also recognize that PU 320 may also include some internal memory including, for example, cache memory.

Concepts disclosed herein have been explained primarily with reference to a corporate conference. In addition an alternative embodiment is envisioned for any network connected presentation device (e.g., an Internet television). For example, an individual watching a World War II documentary on television could be presented with selection links that point to supporting information. The supporting information could augment information being presented in the documentary. For example, a link to major battles of the war could be presented in a window on the television such that when the link is selected information about the battles could be retrieved.

As a further example, a presenter in a UCC or a television show commentator could be talking about Moscow and showing a picture of Red Square. Object recognition could recognize that a picture of Red Square is being displayed on the Screen or in presentation material (e.g., power point slide) and links pertaining to Red Square would be generated. Additionally, if the presenter/commentator was talking about a certain date of an event then links pertaining to events around that date having to do with Red Square could be generated. Thus the viewer/participant could select one of the links and be presented with material to augment what is being shown.

Alternatively or in addition to the above examples, a user presentation could be “seeded” with keyword information or pre-defined selectable links. The pre-defined selectable links could be automatically displayed on a participants user interface at an appropriate time during the presentation. Of course, pre-seeded keyword information and links could be subject to filtering based on a user profile or session preferences. The pre-seeded information may not necessarily be displayed as part of the presentation material but instead be “hidden” information that can be extracted by the automated processes described herein. In this manner, the presentation itself does not have to become cluttered with visible link information.

Aspects of the invention are described as a method of control or manipulation of data, and may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, illustrative blocks of FIGS. 2 and 3 may be performed in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIGS. 2 and 3 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of automatically generating and presenting selection links to supporting data relative to information being presented in a unified communications and collaboration (UCC) session, the method comprising:
obtaining presentation material from one or more sources;
processing, on a processing device, at least a portion of the obtained presentation material to extract keywords pertaining to subject matter contained in the processed presentation material;
providing one or more of the extracted keywords to a search engine function;
receiving results from the search engine function;
processing, on the processing device, at least a portion of the received results; and
providing one or more selection links for presentation wherein the one or more selection links are based on the processed results and wherein a selection of the one or more selection links initiates presentation of information referenced by the selection link.

2. The method of claim 1 wherein processing results returned from the search engine function comprises performing a mashup function.

3. The method of claim 2 wherein user provided filters are applied to results returned from the mashup function prior to presenting one or more selection links.

4. The method of claim 1 further comprising:
obtaining a user profile defining levels of expertise for an associated user; and
applying a filter based on the user profile prior to presenting the one or more selection links.

5. The method of claim 1 wherein user provided filters are applied to extracted keywords prior to providing the one or more extracted keywords to a search engine function.

6. The method of claim 1 wherein user provided filters are provided to the search engine function to limit search results based on an information category or a result type.

7. The method of claim 1 wherein the one or more sources are selected from the group consisting of electronic documents, audio data, video data, image data, and whiteboard data.

8. The method of claim 1 wherein processing at least a portion of the obtained presentation materials further comprises performing speech to text conversion on audio data.

9. The method of claim 1 wherein processing at least a portion of the obtained presentation materials further comprises using software to perform object recognition on video data or image data.

10. The method of claim 1 further comprising invoking the search engine function to search one or more of a content distribution system, Internet sites, or an enterprise workspace.

11. A computer system configured to automatically provide selection links determined from presented content, the computer system comprising:
a programmable control device;
a network interface communicatively coupled to the program control device; and
a display device communicatively coupled to the program control device;
wherein the programmable control device is configured with executable instructions to cause the programmable control device to:
obtain information pertaining to presentation material from one or more sources;
process at least a portion of the obtained information to extract keywords pertaining to subject matter contained in the processed information;
provide one or more of the extracted keywords to a search engine function;
receive results from the search engine function;
process at least a portion of the received results; and
provide one or more selection links for presentation, wherein the one or more selection links are based on the processed results and wherein a selection of the one or more selection links initiates presentation of information referenced by the selection link.

12. The computer system of claim 11 wherein the information pertaining to presentation material is obtained via the network interface.

13. The computer system of claim 11 wherein the information pertaining to presentation material is obtained via an audio interface.

14. The computer system of claim 11 wherein the information pertaining to presentation material is obtained via a video interface.

15. The computer system of claim 13 wherein the executable instructions to cause the programmable control device to process at least a portion of the obtained information comprise executable instructions to cause the programmable control device to perform speech to text conversion on audio data.

16. The computer system of claim 14 wherein the executable instructions to cause the programmable control device to process at least a portion of the obtained information comprise executable instructions to cause the programmable control device to perform object recognition on video or image data.

17. The computer system of claim 11 wherein the presentation material comprises audio information.

18. A non-transitory computer readable medium comprising computer executable instructions tangibly embodied thereon to cause one or more programmable processing units to:
obtain information pertaining to presentation material from one or more sources;
process at least a portion of the obtained information to extract keywords pertaining to subject matter contained in the processed information;
provide one or more of the extracted keywords to a search engine function;
receive results from the search engine function;
process at least a portion of the received results; and
provide one or more selection links for presentation, wherein the one or more selection links are based on the processed results and wherein a selection of the one or more selection links initiates presentation of information referenced by the selection link.

19. The non-transitory computer readable medium of claim 18 wherein the executable instructions to process at least a portion of the obtained presentation material further comprise executable instructions to perform speech to text conversion on audio data.

20. The non-transitory computer readable medium of claim 18 wherein the executable instructions to process at least a portion of the obtained presentation material further comprise executable instructions to perform object recognition on video data or image data.
